(19) United States
(12) Patent Application Publication
(10) Pub. No.: US 2019/0255761 A1
(43) Pub. Date: Aug. 22, 2019

(54) PLASTIC STRAP AND METHOD FOR PRODUCING A PLASTIC STRAP

(71) Applicant: TEUFELBERGER Ges.m.b.H., Wels (AT)

(72) Inventor: Thomas GAHLEITNER, Krenglbach (AT)

(73) Assignee: TEUFELBERGER Ges.m.b.H., Wels (AT)

(21) Appl. No.: 16/348,717

(22) PCT Filed: Nov. 9, 2017
(86) PCT No.: PCT/AT2017/060300

§ 371 Date: May 9, 2019

(30) Foreign Application Priority Data
Nov. 11, 2016 (DE) 10 2016 121 651.8

(51) Int. Cl. B29C 59/04; B29C 59/02; B65D 63/10

(52) U.S. Cl. CPC B29C 59/046; B29K 2023/12; B65D 63/10; B29C 59/022

(57) ABSTRACT

The invention relates to a plastic strap and to a method for producing plastic straps. The plastic strap comprises a partially crystalline thermoplastic material which extends monoaxially or predominantly monoaxially. At least one strap surface is provided with a continuous embossing. The embossing has recesses distributed over the strap surface, which comprise flat or predominantly flat base surfaces. Between 44% and 55% of a parallel projection, viewed from the vertical top view, of the entire at least one embossed strap surface of the plastic strap is formed by the total amount of the base surfaces of the recesses.

The invention relates to a method for producing a plastic strap as well as to a plastic strap.

In the packaging industry, plastic straps are used to an increasing extent instead of metal straps or steel straps most commonly used before. These plastic straps usually mainly consist of a partially crystalline thermoplastic material which is extended monoaxially or at least predominantly monoaxially in the production process. During this extension process, the macromolecule chains are oriented predominantly along the respective main direction of extension. In this respect, the main direction of extension in most cases at least predominantly corresponds to a direction of longitudinal expansion of the final plastic straps.

Due to this preferred orientation of the macromolecule chains of the plastic material, the plastic straps have high tensile strengths/tear strengths which are at least similar to the tensile strengths of metal straps. In particular in highly extended plastic materials, the tensile strength may even exceed that of a metal strap. Apart from that, due to this preferred orientation of the macromolecules, extended plastic straps also have an increased tendency towards tearing or fraying along the longitudinal expansion or along the main direction of extension, which is to be taken into consideration both during production as well as subsequent use.

A strapping process first of all requires wrapping of the goods to be strapped/to be bundled. Subsequently, the straps are clamped and the two longitudinal ends of the straps are connected to one another. The two longitudinal ends/strap ends can advantageously be welded together in plastic straps. In the so-called hot wedge connection, the two longitudinal ends to be connected are surface heated/melted by means of a hot wedge, for example a metal tongue, and subsequently pressed against one another for material connection. The most frequently used method is the so-called friction welding. In this method, the two longitudinal ends are pressed onto one another and moved against one another alternately. The friction heat released during this process causes the longitudinal ends to soften and these are welded together due to the applied pressure.

In modern practice of packaging and securing goods, strapping processes are often carried out partially or even fully automatically by means of strapping apparatuses. Both hand-held devices as well as fully automatic machines are used. In both cases, the straps must be manageable by means of the respectively provided tools, for example guiding and/or clamping and/or welding tools. In this respect, smooth surfaces are often problematic, as slipping between the strap and the tools, in particular during clamping and welding, may occur.

For the purpose of improved guidability, clampability and weldability in strapping processes supported by machines or carried out fully automatically, embossings may be applied on plastic straps. Such embossings may have the effect that the corresponding plastic straps are easier to manage and weld by machine.

Such embossings may be mechanically impressed into a surface of a strap or applied onto a strap surface. Often, embossing rollers, i.e. rollers comprising a structured embossing surface, are used. However, such processing of surfaces during production always bears a certain risk of damaging the strap itself. As already mentioned, such monoaxially extended straps in particular show a high tendency towards tearing or fraying along the longitudinal expansion, often also referred to as splitting.

Moreover, mechanical processing of surfaces for impressing an embossing into a plastic strap may negatively affect the properties of the strap. By an embossing, in particular by material displacement, recesses are impressed into the plastic material, such that a strap thickness in the area of these recesses is greatly reduced. This may, in turn, for example negatively affect the tensile strength/the tear strength of the straps which is important to the formation of secure strappings.

For these reasons, in the past, such processing of surfaces was merely carried out limitedly. In particular, the extent of recesses impressed into a surface of a strap was limited so as not to impair the mechanical properties, in particular the tensile strength.

Thus, there still is a need for optimizing methods for mechanical processing of surfaces/for embossing of plastic straps and a need for providing plastic straps with improved properties, which, especially with respect to strapping of goods, have the best possible mechanical properties and at the same time show a processability by machine for the formation of strappings that is as efficient and error-free as possible.

It was the object of the present invention to provide an improved method of producing plastic straps as well as an improved plastic strap, by means of which strapping processes may be carried out as efficiently as possible in order to allow for a stable and secure strapping of goods.

This object is achieved by a method for producing a plastic strap as well as a plastic strap in accordance with the claims.

The method for producing plastic straps comprises the provision of a partially crystalline thermoplastic material and melting of the plastic material. Moreover, the melted plastic material is extruded into at least one plastic strand by means of an extrusion apparatus. Subsequently, the extruded plastic strand is cooled down, in particular by means of a cooling apparatus. Subsequently, the plastic strand is monoaxially or predominantly monoaxially extended into an extended strand by means of a stretching device. This extended strand comprises two surfaces spaced from one another by a thickness of the extended strand.

At least one surface of the extended strand is provided with an embossing, in particular with a continuous embossing, by means of an embossing device comprising at least one embossing roller. The at least one embossing roller comprises on its roller surface projections for generating recesses on the at least one surface of the extended strand.

It is essential that, as the at least one embossing roller, an embossing roller is used, the projections of which comprise flat or predominantly flat plateau surfaces for generating flat or predominantly flat base surfaces/base areas of the recesses on the at least one surface of the extended strand. At that, the plateau surfaces of the projections are dimensioned such, and the projections are arranged on the roller surface spaced from one another such, that between 44% and 55% of a respective entire parallel projection, viewed from the vertical top view, of the respective at least one embossed strap surface of the final plastic straps is formed by the total amount of the base surfaces of the recesses.

In the course of the embossing process, the impression of the recesses results in material displacement, such that between the recesses/between the base surfaces, bridge-like elevations/protrusions are formed. A strap thickness of the plastic strap is thus decreased by the embossing/in the course of the embossing process in the area of the recesses and increased in the area of the elevations at least in some portions. The plateau surfaces of the projections may for example comprise dimensions/expansions in a three-digit micrometer to one-digit millimeter range. In principle, a geometric shape of the plateau surfaces may be selected randomly. However, certain geometric embodiments may provide additional advantages, as will be elucidated below. A respective geometric shape of a plateau surface is respectively at least predominantly transferred onto the/into the surface of the extended strand in the course of the embossing process, such that the base surfaces of the recesses at least essentially have the same geometric shape as the plateau surfaces of the projections.

By means of the method, plastic straps may be provided which have good mechanical properties, in particular high tensile strengths. Moreover, the produced plastic straps may excellently be manufactured into strappings by machine. In particular, the plastic straps may very well be guided, clamped and welded by machine/partially or fully automatically. By means of the indicated measures, the plastic straps may be produced without an increased risk of damage during or after production.

Surprisingly, it became apparent in this respect that the comparatively large surface area of impressed recesses does not significantly affect the mechanical properties of the plastic straps. This may be associated with the elevations generated in the course of embossing/the embossing process between the impressed recesses. Hence, plastic straps with a high tensile strength may be produced, in which the risk of tearing during the formation of a strapping, or subsequently, is minimized as far as possible despite the percentage of base surfaces of the recesses which is relatively high as compared to the overall area.

Moreover, it is advantageous that plastic straps with a comparatively low surface weight/a comparatively low weight per meter may be produced, which still have excellent properties, in particular high tensile strengths. In this respect, it appears that the reduced strap thickness in the area of the recesses can at least widely be compensated by the elevations formed between the recesses. With respect to processing by machine for the formation of a strapping, it is additionally of specific advantage that a stiffness may even be further increased by the indicated measures/due to the increased strap thickness in the area of the bridge-shaped elevations.

In principle, all extendable/stretchable partially crystalline plastic materials or mixtures/blends of these plastic materials may be provided as thermoplastic material. A thermoplastic material within the meaning of the present description is a meltable/weldable, polymeric organic solid, which may be produced synthetically or semi-synthetically from monomeric organic molecules and/or biopolymers. A partially crystalline thermoplastic material may for example be selected from the group of polyolefins, polyesters or polyamides, or mixtures of these polymers. In particular, a plastic material from the group of polyolefins or polyesters, or mixtures thereof may be provided. Moreover, fillers or additives may be admixed to the provided plastic material.

In a further embodiment it may be provided for that, as the at least one embossing roller, an embossing roller is used, the plateau surfaces of the projections of which are dimensioned such, and the projections of which are arranged on the roller surface spaced from one another such, that between 45% and 52% of the respective entire parallel projection, viewed from the vertical top view, of the respective at least one embossed strap surface of the plastic straps is formed by the total amount of the base surfaces of the recesses.

By impressing an embossing with the indicated percent range for the total amount of the base surfaces, plastic straps may be produced which are particularly suitable for partially or fully automatic formation of strappings by machine.

Moreover, it may be provided for that, as the at least one embossing roller, an embossing roller with projections is used, the plateau surfaces of which are bounded or limited by closed, oval curves.

This allows for plastic straps to be produced, which are again further improved in particular with respect to clamping and welding by friction welding by machine. This is mainly due to the fact that during the formation of a strapping, a transmission of force from a clamping or closing apparatus to the plastic strap that is as uniform as possible may take place. Moreover, in the course of the welding process, faster softening of the thermoplastic material may be achieved, which may reduce the timespan required for the formation of a strapping. As opposed to boundary lines that are straight in portions, by means of plateau surfaces with closed, oval boundary lines, recesses may be impressed into the plastic straps, for which the tendency towards a disadvantageous mutual entangling of the two longitudinal ends of a plastic strap may be further minimized

In a further embodiment of the method, it may also be provided for that the at least one embossing roller is positioned such in relation to the surface of the extended strand facing the embossing roller, that, in the course of embossing, the plateau surfaces of the projections enter into the extended strand with a penetration depth of between 2% and 48% relative to the thickness of the extended strand before embossing.

Hence, on the one hand damage during the production and during use of the plastic straps may be effectively impeded. Still, recesses with a sufficient depth may be generated, such that the plastic straps correspondingly provided with the embossing have advantageous properties in particular with respect to clamping and welding by machine.

However, it may also be useful if the embossing process is carried out at a temperature chosen from a range between 40° C. and 190° C. below the melting temperature of the plastic material.

Hence, damage in the course of the embossing process may be impeded, as a sufficient plasticity of the thermoplastic material may be provided. However, the preferred orientation of the macromolecule chains, applied by means of the previous extension process, is not significantly affected thereby. Moreover, the indicated relative temperature range is useful, as the impressed embossing/the embossed structure directly after embossing may be preserved at least widely. At that, the temperature range in which the embossing process is carried out may also be chosen taking into consideration the selected plastic material.

In a preferred variant of the method, it may be provided for that the extended strand is fed through between at least two counter-rotating embossing rollers opposing each other and that both surfaces of the extended strand are respectively provided with an embossing by means of the two embossing rollers.

This may inter alia be of advantage as for processing by machine for the formation of a strapping, a check whether an embossed surface faces the operating range could be dispensed with. In particular, the actual friction welding process may also be further improved, as the applied friction energy distributes over a smaller area. Hence, a more efficient/faster softening of the plastic material may be achieved, such that both the required energy expenditure as well as the required time for welding may be reduced.

At that, it may moreover be useful if embossing rollers are used, which are respectively used with projections with differently formed plateau surfaces as compared to one another, and that by means of the two embossing rollers, the surfaces of the extended strand are provided with recesses respectively having differently formed base surfaces.

Hence, for example, an embossed structure optimized with respect to guiding or clamping by machine may be impressed on one strap surface of the plastic strap. On the other strap surface, for example, an embossed structure optimized with respect to a friction welding process may be applied. In case of processing by machine for the formation of a strapping, the two different embossed structures/different base surfaces of the recesses may add to each other in a synergistic way. Altogether, hence, plastic straps again further improved with respect to a strapping process by machine may be produced.

However, the object of the invention is also achieved by a plastic strap with a longitudinal expansion and, perpendicular to it, a strap width and a variable strap thickness of the plastic strap, said longitudinal expansion and strap width forming two strap surfaces distanced from one another by a respective strap thickness. The plastic strap comprises a partially crystalline thermoplastic material, said plastic material being extended monoaxially or predominantly monoaxially towards the longitudinal expansion. At least one of the strap surfaces is provided with a continuous embossing.

At that, it is provided for that the embossing comprises recesses distributed over the strap surface, said recesses comprising flat or predominantly flat base surfaces. Between 44% and 55% of a parallel projection, viewed from the vertical top view, of the entire at least one embossed strap surface of the plastic strap is/are formed by the total amount of the base surfaces of the recesses.

A corresponding plastic strap may in particular be produced in a method with the method measures indicated in the present description. Between the recesses, bridge-like elevations are provided respectively, which separate the individual recesses from one another. The strap thickness of the plastic strap is lower in the area of the recesses as compared to the strap thickness in the area of the elevations. In principle, the base surfaces of the recesses may be designed/formed randomly, while certain geometric embodiments of the base surfaces may provide additional advantages, as will be described below. The dimensions/expansions of the base surfaces of the recesses may for example be in a three-digit micrometer to one-digit millimeter range.

A plastic strap with the indicated features has good mechanical properties, in particular high tensile strengths. Moreover, the plastic strap is very well suited for processing by machine for the formation of strappings. In particular, it became apparent that the plastic strap may excellently be guided, clamped and welded by machine.

Surprisingly, it became apparent in this respect that the comparatively large surface area of impressed recesses/base surfaces of the recesses does not significantly affect the mechanical properties of the plastic strap. This may be associated with the elevations located between the recesses. Hence, a plastic strap with a high tensile strength may be provided, in which the risk of tearing during the formation of a strapping, or subsequently, is minimized as far as possible despite the percentage of base surfaces of the recesses which is relatively high as compared to the overall area.

Moreover, it is advantageous that the plastic strap may have a comparatively low surface weight/weight per meter, and may still have excellent properties, in particular high tensile strengths. In this respect, the reduced strap thickness in the area of the recesses may at least widely be compensated by the elevations formed between the recesses. With respect to processing by machine for the formation of a strapping, it is additionally of specific advantage that a stiffness may even be further increased by the indicated features/due to the increased strap thickness in the area of the bridge-shaped elevations.

In a further embodiment of the plastic strap, it may be provided for that between 45% and 52% of a parallel projection, viewed from the vertical top view, of the entire at least one embossed strap surface of the plastic strap is/are formed by the total amount of the base surfaces of the recesses.

Such a plastic strap has particularly advantageous properties with respect to a partially or fully automatic formation of strappings by machine.

Moreover, it may be provided for that the base surfaces of the recesses comprise boundary lines, said boundary lines being formed by closed, oval curves as viewed from the vertical top view onto the base surfaces.

This allows for a plastic strap to be provided, having again further improved properties mainly with respect to clamping and welding by friction welding by machine. This is mainly due to the fact that during the formation of a strapping, a transmission of force from a clamping or closing apparatus to the plastic strap that is as uniform as possible may take place. Moreover, in the course of the welding process, faster softening of the thermoplastic material may be achieved, which may reduce the timespan required for the formation of a strapping. As opposed to boundary lines of the base surfaces that are straight in portions, recesses with base surfaces with oval boundary lines have a significantly lower tendency towards a disadvantageous mutual entangling of the two longitudinal ends of a plastic strap in the course of the welding process.

Furthermore, it may be of advantage if a depth of the recesses amounts to between 50 μm and 400 μm.

By limiting the depth of the recesses, damage of the plastic strap in the course of a use for the formation of a strapping may be effectively counteracted. Nevertheless, the corresponding recesses may have a depth which is sufficient for achieving advantageous properties, mainly with respect to clamping and welding the plastic strap by machine. In particular, a depth of the recesses may amount to between 100 μm and 200 μm.

In principle, the plastic strap may comprise all extendable/stretchable partially crystalline plastic materials or mixtures/blends of these plastic materials as thermoplastic material. A thermoplastic material within the meaning of the present description is a meltable/weldable, polymeric organic solid, which may be produced synthetically or semi-synthetically from monomeric organic molecules and/or biopolymers. A partially crystalline thermoplastic material may for example be selected from the group of polyolefins, polyesters or polyamides, or mixtures of these polymers. Moreover, fillers or additives may be admixed to the provided plastic material.

In particular, it may be provided for that the extended plastic material is formed by a polyolefin, in particular by polypropylene.

However, it may also be useful if the extended plastic material is formed by a polyester, in particular by polyethylene terephthalate.

In both cases, on plastic strap may be provided respectively, which has very good mechanical properties, in particular a high tensile strength.

In a further embodiment of the plastic strap, it may be provided for that both strap surfaces comprise an embossing.

Hence, in particular a friction welding process for connecting the two longitudinal ends may be further improved, as the applied friction energy distributes over a smaller area. A more efficient/faster softening of the plastic material may be achieved, such that both the required energy expenditure as well as the required time for welding may be reduced. It is, moreover, of advantage that for processing by machine for the formation of a strapping, a check whether an embossed surface faces the operating range could be dispensed with.

In this context, it may be a further advantage if the strap surfaces of the plastic strap respectively comprise recesses with differently shaped base surfaces as compared to one another.

Hence, for example, an embossed structure optimized with respect to guiding or clamping by machine may be formed on one strap surface. On the other strap surface, the plastic strap may for example comprise an embossed structure optimized with respect to a welding process. In case of processing by machine for the formation of a strapping, the two different embossed structures/different base surfaces of the recesses may add to each other in a synergistic way. Altogether, hence, plastic straps again further improved with respect to a strapping process by machine may be provided.

For the purpose of better understanding of the invention, it will be elucidated in more detail by means of the figures below.

These show in a respectively very simplified schematic representation:

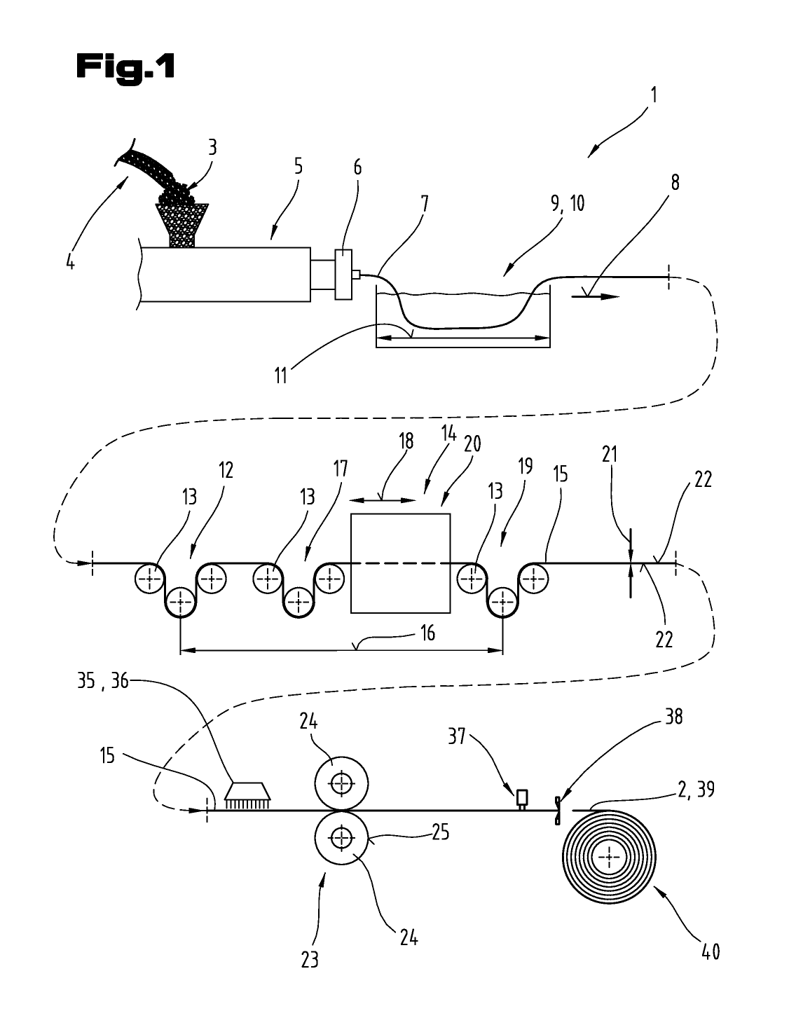

FIG. 1 a schematic representation of a system for producing a plastic strap, which illustrates the method for production;

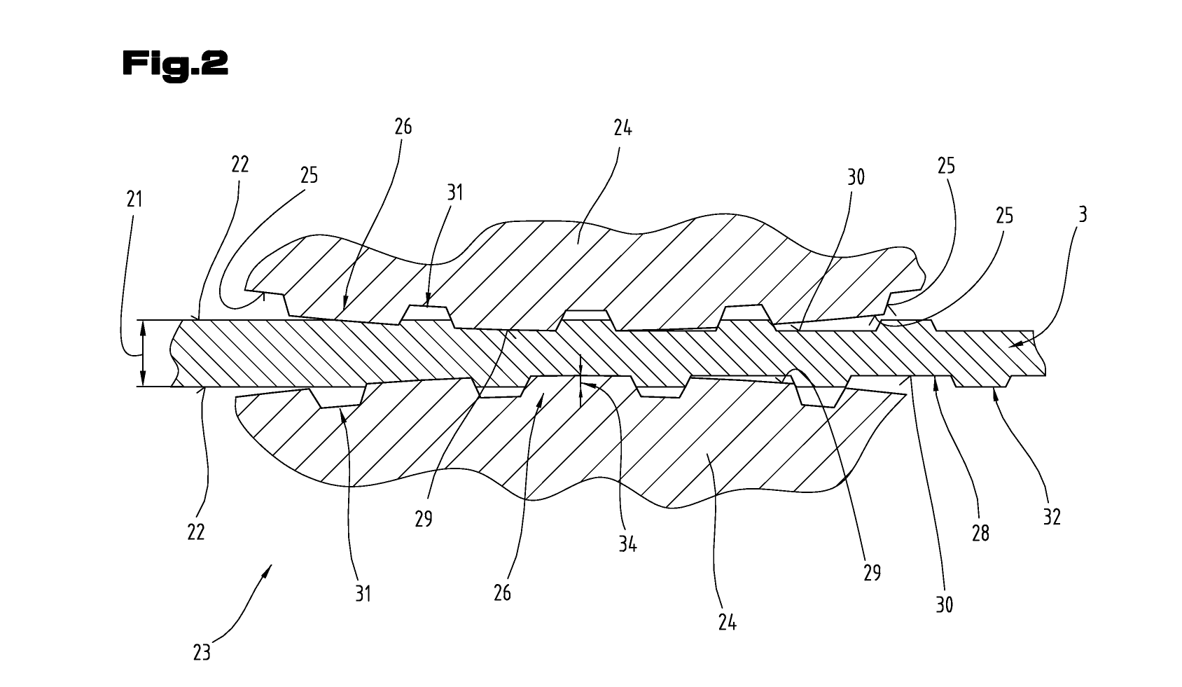

FIG. 2 excerpts from a sectional view of an extended strand and an embossing device with embossing rollers, which illustrates the embossing process;

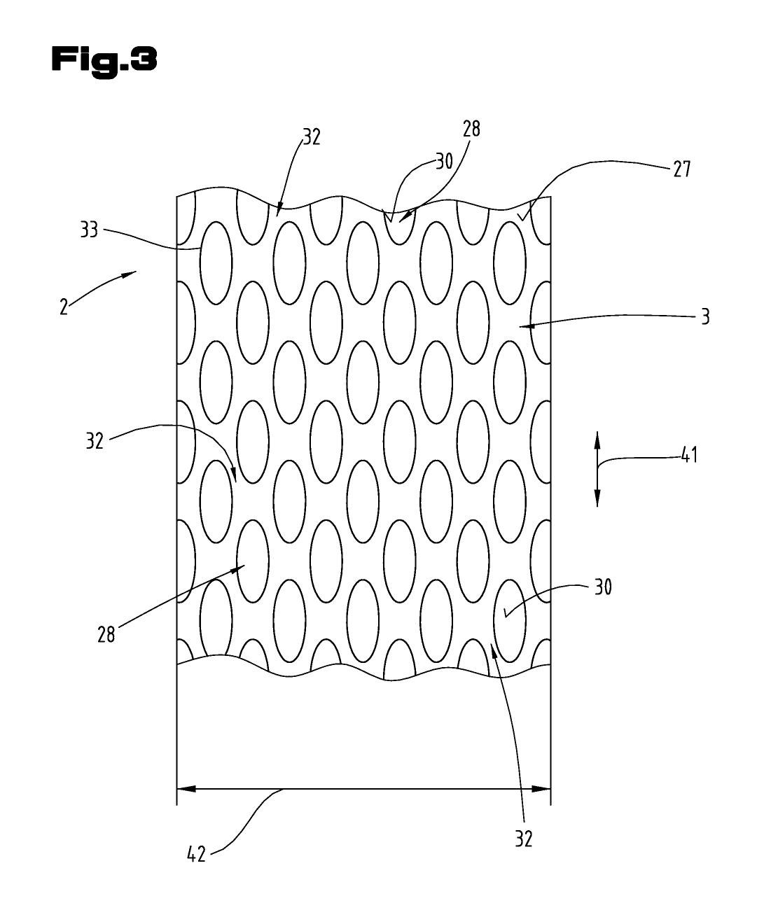

FIG. 3 excerpts from a top view onto a strap surface/a parallel projection of a strap surface of an embossed plastic strap.

First of all, it is to be noted that in the different embodiments described, equal parts are provided with equal reference numbers/equal component designations, where the disclosures contained in the entire description may be analogously transferred to equal parts with equal reference numbers/equal component designations. Moreover, the specifications of location, such as at the top, at the bottom, at the side, chosen in the description refer to the directly described and depicted figure and in case of a change of position, these specifications of location are to be analogously transferred to the new position.

For the avoidance of repetitions, in the following description, individual embodiment variants are not explicitly instanced or illustrated graphically. In this regard, reference is made to the above description respectively. In the entire description, the term “extend” is used synonymously with the term “stretch”.

FIG. 1 schematically illustrates an apparatus 1 for producing/a method for producing plastic straps 2. At the beginning of the method, a partially crystalline thermoplastic material 3 is provided.

In principle, any partially crystalline thermoplastic material 3, which can be thermoplastically preformed, extended and surface treated, may be provided. For example, it may be provided for that a plastic material 3 from the group of polyolefins, polyesters, polyamides, or mixtures/blends of these polymeric materials is provided. Preferably, a polyolefin or polyester is provided as plastic material 3, as these plastic materials are particularly suitable for the production of straps. Polyolefins and polyesters are extrudable very well and may, moreover, be manufactured into plastic straps 2 with a high tensile strength by extension. In particular, a plastic material 3 may be provided, which is formed at least predominantly by polypropylene or by polyethylene terephthalate.

As is schematically depicted in FIG. 1, the partially crystalline thermoplastic material may be supplied/metered via a feeder/metering device 4 of an extrusion apparatus 5. In the course of this, fillers and additives, such as dyes, antioxidants and/or other auxiliaries, may also be admixed to the plastic material 3. In the extrusion apparatus 5, for example in a screw extruder, the thermoplastic material 3 is then melted and extruded via an extrusion tool 6 arranged on the extrusion apparatus 5.

For this purpose, it may be provided for that the extrusion tool 6 comprises one or several die(s), in particular with a slit-shaped cross-section, through which slit die(s) the melted plastic material is pressed/extruded into a strap-shaped plastic strand 7 or into several strap-shaped plastic strands 7. In case of several strap- or strip-shaped plastic strands 7 being extruded, these may run through the subsequent method steps together. Alternatively, it may also be provided for that the extrusion tool 6 comprises a die or a slit die with a large cross-sectional width, i.e. a wide slit die, such that a foil-shaped plastic strand 7 with a large width expansion is extruded. Such a foil-shaped plastic strand 7 may, after the performance of further method steps, respectively be separated into strip- or strap-shaped strands or straps along the longitudinal orientation of the plastic strand 7 in a confectioning step, in order to produce straps with suitable dimensions/width expansions. In any case, by extrusion by means of the extrusion apparatus 5, at least one extruded plastic strand 7 is generated, the primary form/primary cross-sectional geometry of which may be at least essentially determined via the die/the dies on the extrusion tool 6.

After the extrusion, cooling of the extruded plastic strand 7 may be performed, as shown in FIG. 1. Hence, the primary form/the cross-sectional geometry of the extruded plastic strand 7 may be preserved. In principle, passive cooling of the extruded plastic strand 7 by ambient air may be carried out for this purpose. If applicable, an air flow may be used for cooling. Preferably, the extruded plastic strand 7 is guided through a cooling apparatus 9 in a guiding/transport direction 8 for efficient cooling, as is shown in FIG. 1. The depicted cooling apparatus 9 may for example be formed by a water quench 10. The cooling apparatus 9 may for example contain water with a specific temperature, through which the extruded plastic strand 7 is guided. A temperature of the plastic strand 7 after cooling may, for example at a given temperature of a cooling liquid/of the water of the cooling apparatus 9, be influenced or controlled by a specific length 11 of the cooling apparatus 9.

For pulling/guiding the plastic strand 7 in transport direction 8, a puller device 12 may be arranged behind the cooling apparatus 9. As shown in FIG. 1, such a puller device 12 may comprise several roller elements 13 rotating with specific angular speeds, which for example form a trio of galettes. In principle, it may also be provided for in this respect, that one or several roller element(s) are designed temperably, such that the plastic strand 7 may be heated or cooled for the subsequent further processing, in particular the stretching process. For this purpose, a roller element 13 may for example temperable by means of temperature-control liquids or electrically. Alternatively, other means for temperature control of a plastic strand 7, such as sprinkler devices, immersion baths or infrared radiators, may be arranged for heating or cooling the plastic strand 7.

The stretching process/extending the plastic strand 7 into an extended strand 15 is, as shown in FIG. 1, carried out by means of a stretching device 14. For this purpose, a further transport/puller device 17 with roller elements 13 may be arranged along a stretching path 16 of the stretching device 14. All roller elements 13 shown in FIG. 1 may rotate with different angular speeds respectively for the respective determination of a pulling/movement speed for the plastic strand 7 during performance of the method. As regards the angular speed during rotation, a respective perimeter of the individual roller elements 13 is of course also to be taken into consideration in this respect. For ease of illustration, all roller elements 13 have the same perimeter in FIG. 1. Generally, such roller elements 13 may of course also have different perimeters.

In the embodiment shown in FIG. 1, it may be provided for that the roller elements 13 of the puller device 17 rotate with a higher angular speed than the roller elements 13 of the preceding puller device 12. Hence, a pulling speed/transport speed of the further puller device 17 is selected to be larger that the pulling speed for the plastic strand 7 of the preceding puller device 12 and the plastic strand 7 is extended along a main direction of extension 18 or, in other words, drawn out.

Moreover, an additional transport/puller device 19 may be provided at the end of the stretching device 14/the stretching path 16. In this additional puller device 19, during operation of the apparatus 1, an even higher pulling speed for the plastic strand 7 than the pulling speed of the puller device 17 arranged ahead with respect to the transport direction 8 may be provided.

Hence, the plastic strand 7 may be even further drawn out/extended between the further puller device 17 and the additional puller device 19. In total, the plastic strand 7 is monoaxially or at least predominantly monoaxially stretched/extended into an extended strand 15 in the stretching device 14/along the stretching path 16 along the main direction of extension 18.

A ratio of extension for the plastic material 3 may be selected from a range between 2 and 20 for the extended strand 15. This relates to the extruded plastic strand 7 prior to the extension process. Thus, in the course of the extension process, a thickness of the plastic strand 7 is also reduced due to the extension. Preferably, a ratio of extension in a range between 3 and 15, in particular between 4 and 12, is selected for the plastic material 3. As can be seen from FIG. 1, the extension may be carried out predominantly along the main direction of extension 18. However, in this respect, minor extensions/stretching transversely to the main direction of extension 18 cannot be entirely precluded, which is why an extended strand 15 may be extended predominantly monoaxially.

The embodiment of a stretching device 14 shown in FIG. 1 merely serves the purpose of schematic illustration and such stretching devices 14 may of course comprise further elements and devices for performing/influencing and controlling the extension process. For example, for better performance of a stretching/of an extension process, it may be provided for that one or several heating devices 20 are provided along the stretching path 16. By means of such heating devices 20, a plastic strand 7 may be brought to a processing temperature that respectively is favorable for the extension process, an advantageous processing temperature inter alia depending on the respectively used/provided plastic material 3.

After extension, an extended strand 15 is given, which has an increased risk of so-called splitting, i.e. tearing or fraying along the main direction of extension 18, due to the preferred orientation of the macromolecules in the main direction of extension 18 now brought into the plastic material. The extended strand 15 comprises two surfaces 22 spaced from one another by a thickness 21 of the extended strand 15.

As is further shown in FIG. 1, at least one surface 22 of the extended strand 15 is provided with an embossing by means of an embossing device 23. For this purpose, the embossing device 23 comprises at least one embossing roller 24. For ease of comprehensibility, the embossing process/the embossing device 23 is shown in FIG. 2 as an enlarged excerpt, with a sectional view of an extended strand 15 and of an embossing device 23 being shown in FIG. 2. In FIG. 2, equal reference numbers/component designations are used for equal parts as in FIG. 1 preceding it. In order to avoid unnecessary repetitions, it is pointed to/reference is made to the detailed description in FIG. 1 preceding it.

As illustrated in FIG. 2, the at least one surface 22 of the extended strand 15 is provided with an embossing, in particular with a continuous embossing. This is also apparent from the illustration of an excerpt in vertical top view/the parallel projection of a strap surface 27 of an embossed plastic strap 2 shown in excerpts according to FIG. 3. In FIG. 3, equal reference numbers/component designations are again used for equal parts as in FIG. 1 and in FIG. 2 preceding it. In order to avoid unnecessary repetitions, it is pointed to/reference is made to the detailed description in FIG. 1 and FIG. 2 preceding it.

The at least one embossing roller 24 comprises on its roller surface 25 projections 26 for generating recesses 28 on the at least one surface 22 of the extended strand 15. In the course of this, the at least one embossing roller 24 is used as an embossing roller 24, the projections 26 of which comprise flat or predominantly flat plateau surfaces 29 for generating flat or predominantly flat base surfaces 30 of the recesses 28 on the at least one surface 22 of the extended strand 15, as can be gathered from FIG. 2. The projections 26 may for example also be referred to as embossing stamp. Moreover, it is essential that the plateau surfaces 29 of the projections 26 are dimensioned such, and that the projections 26 are arranged on the roller surface 25 spaced from one another such, that between 44% and 55% of a respective entire parallel projection, viewed from the vertical top view, of the respective at least one embossed strap surface 27 of the plastic straps 2, see FIG. 3, is formed by the total amount of the base surfaces 30 of the recesses 28.

Preferably, as the at least one embossing roller 24, an embossing roller 24 is used, the plateau surfaces 29 of the projections 26 of which are dimensioned such, and the projections 26 of which are arranged on the roller surface 25 spaced from one another such, that between 45% and 52% of the respective entire parallel projection, viewed from the vertical top view, of the respective at least one embossed strap surface 27 of the plastic straps 2 is formed by the total amount of the base surfaces 30 of the recesses 28.

In principle, it may definitely be provided for that merely one surface 22 of an extended strand 15 is provided with an embossing. Preferably, the extended strand 15 is fed through between at least two counter-rotating embossing rollers 24 opposing each other, such that both surfaces 22 of the extended strand 15 are respectively provided with an embossing by means of the two embossing rollers 24, as shown in FIG. 1 and in FIG. 2. Hence, as regards processability for strapping, again further improved plastic straps 2 may be produced.

The two embossing rollers 24 are arranged such with respect to the two surfaces 22, that the projections act on a passing, extended strand 15 and generate the recesses 28. This results in a material displacement of the plastic material 3, which at least partially enters groove-like indentations 31 arranged between the projections 26 of the embossing roller(s) 24 during the embossing process. Hence, bridge-shaped elevations 32 are formed between the recesses 28/between the base surfaces 30 in an extended strand 15, as is shown in FIG. 2. A strap thickness of the plastic strap is thus decreased by the embossing/in the course of the embossing process in the area of the recesses 28 and increased in the area of the elevations 32 at least in some portions. The elevations 32 may also be referred to as protrusions.

It inter alia depends on the pressure applied to the extended strand 15 by the embossing roller(s) as well as on the general temperature-dependent plasticity of the plastic material 3, how far the plastic material 3 enters into the indentations 31 of the at least one embossing roller 24 during the embossing process. This, as well as the embodiment of the projections 26 influences the geometry and the dimensions of the respective elevations 32. The embodiment of the projections essentially determines the shape of the recesses 28, wherein the recesses 28 may for example transition into the elevations 32 via angled edges, as is illustrated in FIG. 2. The geometric shape and delimitation of the base surfaces 30 is at least predominantly determined by the shape of the plateau surfaces 29 of the projections 26, wherein slight deviations between the embodiment and the dimensions of the plateau surfaces 29 and the embodiment and the dimensions of the base surfaces 30 of the recesses 28 may emerge. This is caused by/depends on the consistency of the plastic material 3, the temperature of the plastic material 3 during the embossing process and other method parameters.

The plateau surfaces 29 of the projections 26 may for example comprise dimensions/expansions in a three-digit micrometer to one-digit millimeter range. A respective geometric shape of a plateau surface 29 is respectively at least predominantly transferred onto the/into the surface 22 of the extended strand 15 in the course of the embossing process, such that the base surfaces 30 of the recesses 28 at least essentially have the same geometric shape and dimensions as the plateau surfaces 29 of the projections 26.

In principle, a geometric shape of the plateau surfaces 29 may be selected randomly. Preferably, as the at least one embossing roller 24, an embossing roller 24 with projections 26 is used, the plateau surfaces 29 of of which are bounded by closed, oval curves. It is thus possible to produce a plastic strap 2, the recesses 28 of which comprise base surfaces 30 with boundary lines 33, said boundary lines 33 being formed by closed, oval curves as viewed from the vertical top view onto the base surfaces 30, as is illustrated by means of the exemplary elliptically designed base surfaces 30 in FIG. 3.

The plateau surfaces 29 of the projections 26 may for example comprise dimensions/expansions in a three-digit micrometer to one-digit millimeter range. At that, the number of projections 26 of the embossing roller(s) 24 may be correspondingly adapted, such that plastic straps 2 may be produced/be embossed, on the strap surfaces 27 of which, viewed from the vertical top view, 44% to 55% of the parallel projection of the embossed strap surfaces 27 are formed by the total amount of the base surfaces 30 of the recesses 28.

In a further embodiment of the method, it may also be provided for that the at least one embossing roller 24 is positioned such in relation to the surface 22 of the extended strand 15 facing the embossing roller 24 in the course of the embossing process, that the plateau surfaces 29 of the projections 26 enter into the extended strand 15 with a penetration depth 34 of between 2% and 48% relative to the thickness 21 of the extended strand 15 before embossing, as illustrated in FIG. 2.

Moreover, it may be useful if the embossing process is carried out at a temperature chosen from a range between 40 and 190° C. below the melting temperature of the plastic material 3. For this purpose, it may for example be provided for that at least one of the embossing rollers 24 shown in the embodiment in FIG. 1 and, as an excerpt, in FIG. 2, is designed temperably. The embossing roller(s) 24 may for example comprise channels for guiding through a tempered, liquid medium. For example, electric heating of at least one embossing roller 24 is possible, too. Alternatively, temperature control of the extended strand 15 by means of a temperature-control device 35 arranged ahead of the embossing device 23 is also possible. As an example for such an upstream temperature-control device 35, a sprinkling device 36 is depicted in FIG. 1, by means of which a tempered liquid may be applied to an extended strand 15. Of course, other means, such as infrared radiators, immersion baths, furnaces and so on, may also be used as the temperature-control device 35.

As already described and illustrated in the embodiments according to FIG. 1 and FIG. 2, preferably, both surfaces 22 of the extended/stretched strand 15 are respectively provided with an embossing. In this context, an embodiment may be useful in which embossing rollers 24 are used, which are respectively used with projections 26 with differently formed plateau surfaces 29 as compared to one another, and that by means of the two embossing rollers 24, the surfaces 22 of the extended strand 15 are provided with recesses 28 respectively having differently formed base surfaces 30.

As illustrated in FIG. 1, further process steps for confectioning of an extended and embossed strand 15 may be provided at the end of the method for producing plastic straps 2. For example, a separation device 37 for separating an extended and surface treated strand 15 into several sub-strands may be arranged. This is particularly suitable for obtaining plastic straps 2 from a foil-shaped strand 15 with a comparatively large width expansion transversely to the transport direction 8. In this respect, it may be provided for that such an extended and embossed strand 15 is separated in terms of its width. The separation device 37 may for example comprise one or several cutting device(s).

Moreover, a split-up device 38 may also be provided for confectioning. Such a split-up device 38 may be adapted to cut one strand 15 or several strands 15, which, if applicable, were obtained by means of separation with the separation device 37, into pieces 39 suitable for storage or transport. For storage or for transport, these pieces 39 may for example be wound up onto coils 40, as is shown in FIG. 1. Such coils 40 may particularly be used for bulk portioning, where plastic straps 2 may be cut into the respectively suitable lengths from such a coil 40 for ultimate use or sale. Alternatively, a direct splitting up into ready-for-use lengths of plastic straps 2 is of course possible, too.

FIG. 3 shows an excerpt of a ready-for-use plastic strap 2 illustrated from the vertical top view onto one of the embossed strap surfaces 27/as a parallel projection. The plastic strap 2 may in particular be produced by means of the described method.

The depicted excerpt of the plastic strap 2 comprises a longitudinal expansion 41 and a strap width 42. The longitudinal expansion 41 and the strap width 42 form two strap surfaces 27 distanced from one another by a respective strap thickness. One of these strap surfaces 27 is depicted in FIG. 3 illustrated from the vertical top view/as a parallel projection. In this regard, a respective strap thickness is respectively directed vertically towards the longitudinal expansion 41 and the strap width 42 and the strap thickness is variable due to the at least one embossing impressed into the plastic strap 2.

The plastic strap 2 comprises a partially crystalline thermoplastic material 3, said plastic material 3 being extended monoaxially or predominantly monoaxially towards the longitudinal expansion 41. The partially crystalline thermoplastic material 3 may for example be selected from the group of polyolefins, polyesters, polyamides or mixtures/blends of these polymeric materials. Preferably, a polyolefin or polyester is selected as the plastic material 3, as these plastic materials are particularly suitable for the production of straps. For example, the plastic material 3 may be formed by polypropylene or by polyethylene terephthalate.

A ratio of extension of the plastic material 3 of the plastic strap 2 may amount to between 2 and 20. This relates to the plastic material 3 prior to the extension process. Preferably, the ratio of extension amounts to between 3 and 15, particularly between 4 and 12. As is apparent from FIG. 3, at least one strap surface 27 is provided with an embossing.

The embossing comprises recesses 28 distributed across the strap surface 27, said recesses 28 comprising flat or predominantly flat base surfaces 30, as best becomes apparent when looking at the combination of FIG. 2 and FIG. 3. Between 44% and 55% of the parallel projection, viewed from the vertical top view, of the entire at least one embossed strap surface 27 of the plastic strap 2 is formed by the total amount of the base surfaces 30 of the recesses 28. A respective base surface 30 of the recesses 28 may also be referred to as base area of a recess 28. Preferably, between 45% and 52% of the parallel projection, viewed from the vertical top view, of the entire at least one embossed strap surface 27 of the plastic strap 2 is formed by the total amount of the base surfaces 30 of the recesses 28.

As illustrated by means of the embodiment shown in FIG. 3, the base surfaces 30 of the recesses 28 may comprise boundary lines 33, said boundary lines 33 being formed by closed, oval curves as viewed from the vertical top view onto the base surfaces 30. For example, the boundary lines 33 of the base surfaces/areas 30 of the recesses 28 may be formed elliptically.

A depth of the recesses 28 may for example amount to between 50 and 400 μm. In particular, it may be provided for that a depth of the recesses 28 amounts to between 100 μm and 200 μm.

For ease of illustration, one of the embossed strap surfaces 27 of the plastic strap 2 is depicted in FIG. 3. In a preferred embodiment of the plastic strap 2, both strap surfaces 27 may comprise a continuous embossing, as may also be gathered from FIG. 2. In this case, it may moreover be provided for that the strap surfaces 27 respectively comprise recesses 28 with differently shaped base surfaces 30 as compared to one another.

The embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | apparatus |
| 2 | plastic strap |
| 3 | plastic material |
| 4 | metering device |
| 5 | extrusion apparatus |
| 6 | extrusion tool |
| 7 | plastic strand |
| 8 | transport direction |
| 9 | cooling apparatus |
| 10 | water quench |
| 11 | length |
| 12 | puller device |
| 13 | roller element |
| 14 | stretching device |
| 15 | strand |
| 16 | stretching path |
| 17 | puller device |
| 18 | main direction of extension |
| 19 | puller device |
| 20 | heating device |
| 21 | thickness |
| 22 | surface |
| 23 | embossing device |
| 24 | embossing roller |
| 25 | roller surface |
| 26 | projection |
| 27 | strap surface |
| 28 | recess |
| 29 | plateau surface |
| 30 | base surface |
| 31 | indentation |
| 32 | elevation |
| 33 | boundary line |
| 34 | penetration depth |
| 35 | temperature-control device |
| 36 | sprinkling device |
| 37 | separation device |
| 38 | split-up device |
| 39 | piece |
| 40 | coil |
| 41 | longitudinal expansion |
| 42 | strap width |

1. A method for producing plastic straps (2), comprising
providing a partially crystalline thermoplastic material (3), melting the plastic material (3),
extruding the melted plastic material into at least one plastic strand (7) by means of an extrusion apparatus (5),
cooling the extruded plastic strand (7), monoaxially or predominantly monoaxially extending the plastic strand (7) into an extended strand (15) by means of at least one stretching device (14), said extended strand (15) comprising two surfaces (22) spaced from one another by a thickness (21) of the extended strand (15),
wherein at least one surface (22) of the extended strand (15) is provided with an embossing by means of an embossing device (23) comprising at least one embossing roller (24),
said embossing roller (24) comprising on its roller surface (25) projections (26) for generating recesses (28) on the at least one surface (22) of the extended strand,
wherein
as the at least one embossing roller (24), an embossing roller (24) is used, the projections (26) of which comprise flat or predominantly flat plateau surfaces (29) for generating flat or predominantly flat base surfaces (30) of the recesses (28) on the at least one surface (22) of the extended strand (15),
wherein the plateau surfaces (29) of the projections (26) are dimensioned such, and wherein the projections (26) are arranged on the roller surface (25) spaced from one another such, that between 44% and 55% of a respective entire parallel projection, viewed from the vertical top view, of the respective at least one embossed strap surface (27) of the plastic straps (2) is formed by the total amount of the base surfaces (30) of the recesses (28).

2. The method according to claim 1, wherein as the at least one embossing roller (24), an embossing roller (24) is used, the plateau surfaces (29) of the projections (26) of which are dimensioned such, and the projections (26) of which are arranged on the roller surface (25) spaced from one another such, that between 45% and 52% of the respective entire parallel projection, viewed from the vertical top view, of the respective at least one embossed strap surface (27) of the plastic straps (2) is formed by the total amount of the base surfaces (30) of the recesses (28).

3. The method according to claim 1, wherein as the at least one embossing roller (24), an embossing roller (24) with projections (26) is used, the plateau surfaces (29) of which are bounded by closed, oval curves.

4. The method according to claim 1, wherein the at least one embossing roller (24) is positioned such in relation to the surface (22) of the extended strand (15) facing the embossing roller (24), that, in the course of embossing, the plateau surfaces (29) of the projections (26) enter into the extended strand (15) with a penetration depth (34) of between 2% and 48% relative to the thickness (21) of the extended strand (15) before embossing.

5. The method according to claim 1, wherein the embossing process is carried out at a temperature chosen from a range between 40° C. and 190° C. below the melting temperature of the plastic material (3).

6. The method according to claim 1, wherein the extended strand (15) is fed through between at least two counter-rotating embossing rollers (24) opposing each other and wherein both surfaces (22) of the extended strand (15) are respectively provided with an embossing by means of the two embossing rollers (24).

7. The method according to claim 6, wherein embossing rollers (24) are used, which are respectively used with projections (26) with differently formed plateau surfaces (29) as compared to one another, and wherein by means of the two embossing rollers (24), the surfaces (22) of the extended strand (15) are provided with recesses (28) respectively having differently formed base surfaces (30).

8. A plastic strap (2) with a longitudinal expansion (41) and perpendicular to it, a strap width (42) and a variable strap thickness of the plastic strap (2), said longitudinal expansion (41) and strap width (42) forming two strap surfaces (27) distanced from one another by a respective strap thickness,
wherein the plastic strap (2) comprises a partially crystalline thermoplastic material (3), said plastic material (3) being extended monoaxially or predominantly monoaxially towards the longitudinal expansion (41),
and wherein at least one strap surface (27) is provided with a continuous embossing,
wherein
the embossing comprises recesses (28) distributed over the strap surface (27), said recesses (28) comprising flat or predominantly flat base surfaces (30), and wherein between 44% and 55% of a parallel projection, viewed from the vertical top view, of the entire, at least one embossed strap surface (27) of the plastic straps (2) is formed by the total amount of the base surfaces (30) of the recesses (28).

9. The plastic strap according to claim 8, wherein between 45% and 52% of the parallel projection, viewed from the vertical top view, of the entire at least one embossed strap surface (27) of the plastic strap (2) is formed by the total amount of the base surfaces (30) of the recesses (28).

10. The plastic strap according to claim 8, wherein the base surfaces (30) of the recesses (28) comprise boundary lines (33), said boundary lines (33) being formed by closed, oval curves as viewed from the vertical top view onto the base surfaces (30).

11. The plastic strap according to claim 8, wherein a depth of the recesses (28) amounts to between 50 μm and 400 μm.

12. The plastic strap according to claim 8, wherein both strap surfaces (27) comprise a continuous embossing.

13. The plastic strap according to claim 12, wherein the strap surfaces (27) respectively comprise recesses (28) with differently shaped base surfaces (30) as compared to one another.
